(19) United States
(12) Patent Application Publication
(10) Pub. No.: US 2025/0007047 A1
(43) Pub. Date: Jan. 2, 2025

(54) SECONDARY BATTERY

(71) Applicant: TOYOTA JIDOSHA KABUSHIKI KAISHA, Toyota-shi (JP)

(72) Inventors: Yosuke SHIMURA, Toyota-shi (JP); Yoshiro Obayashi, Toyota-shi (JP); Atsushi Yamanaka, Nagoya-shi (JP); Masashi Chihara, Nagoya-shi (JP); Kazuki Sugie, Miyoshi-shi (JP); Kosuke Yonekawa, Nisshin-shi (JP); Yasuhiro Hirao, Toyota-shi (JP)

(73) Assignee: TOYOTA JIDOSHA KABUSHIKI KAISHA, Toyota-shi (JP)

(21) Appl. No.: 18/734,023

(22) Filed: Jun. 5, 2024

(30) Foreign Application Priority Data
Jun. 27, 2023 (JP) 2023-104708

(51) Int. Cl. H01M 50/103; H01M 50/186; H01M 50/645

(52) U.S. Cl. CPC H01M 50/103; H01M 50/186; H01M 50/645

(57) ABSTRACT

In a secondary battery, a main body of a housing includes a bottom surface portion, a first side surface portion, a second side surface portion, a first top surface portion, a second top surface portion, and a weld. The first top surface portion extends toward the second side surface portion, from an end of the first side surface portion opposite to the bottom surface portion. The second top surface portion extends toward the first side surface portion, from an end of the second side surface portion opposite to the bottom surface portion. The weld connects respective leading ends of the first top surface portion and the second top surface portion to each other.

### CROSS REFERENCE TO RELATED APPLICATIONS

This nonprovisional application is based on Japanese Patent Application No. 2023-104708 filed on Jun. 27, 2023 with the Japan Patent Office, the entire contents of which are hereby incorporated by reference.

### BACKGROUND

### Field

The present disclosure relates to a secondary battery.

### Description of the Background Art

Japanese Patent Laying-Open No. 2013-143332 discloses a battery which is joined by forming a weld at an abutment portion between a battery case and a lid.

### SUMMARY

In order to improve the energy density of the secondary battery, it is required to increase the size of the housing of the secondary battery. In the battery disclosed in Japanese Patent Laying-Open No. 2013-143332, an opening end portion is formed on the upper side of the battery case (housing). A lid portion is connected to the opening end portion by welding. When the housing of such a battery becomes longer in the width direction orthogonal to the height direction, the weld length of the opening end portion becomes longer. This may further increase the welding strain of the housing. Consequently, the dimensional accuracy of the housing may be reduced.

The present disclosure is made in view of the above problem, and it is an object of the present disclosure to provide a secondary battery in which welding strain of a housing is suppressed and dimensional accuracy of the housing is improved.

A secondary battery according to the present disclosure includes an electrode assembly and a housing. The housing contains the electrode assembly. The housing has a dimension in a height direction, a dimension in a thickness direction, and a dimension in a width direction longer than the dimension in the height direction and the dimension in the thickness direction. The thickness direction is orthogonal to the height direction. The width direction is orthogonal to both the height direction and the thickness direction. The housing includes a main body, a first sealing body, and a second sealing body. The main body has a tubular shape. The main body is provided with a first opening and a second opening that are located on opposite ends in the width direction, respectively. The first sealing body closes the first opening. The second sealing body closes the second opening. The main body includes a bottom surface portion, a first side surface portion, a second side surface portion, a first top surface portion, a second top surface portion, and a weld. The bottom surface portion is located on one side in the height direction. The first side surface portion extends upright along the height direction, from one end of the bottom surface portion in the thickness direction. The second side surface portion extends upright along the height direction, from the other end of the bottom surface portion in the thickness direction. The first top surface portion extends toward the second side surface portion, from an end of the first side surface portion, the end being located opposite to the bottom surface portion. The second top surface portion extends toward the first side surface portion, from an end of the second side surface portion, the end being located opposite to the bottom surface portion. The weld connects a leading end of the first top surface portion and a leading end of the second top surface portion to each other.

In the above configuration, since the leading ends are welded to each other, the welding length on the side opposite to the bottom surface portion can be shortened as compared with the case where the housing has the opening on the side opposite to the bottom surface portion. Consequently, welding strain of the housing can be suppressed. Consequently, the dimensional accuracy of the housing is improved.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a secondary battery according to a first embodiment.

FIG. 2 is an exploded perspective view of the secondary battery according to the first embodiment.

FIG. 3 is a cross-sectional view taken along the line III-III shown in FIG. 1.

FIG. 4 is a plan view of the secondary battery according to the first embodiment.

FIGS. 5A and 5B are diagrams schematically showing a process of molding the main body portion in the first embodiment.

FIG. 6 is a cross-sectional view taken along the line VI-VI shown in FIG. 1.

FIG. 7 is a plan view of a secondary battery according to a second embodiment.

FIGS. 8A and 8B are diagrams schematically showing a process of molding the main body portion in the second embodiment.

### DESCRIPTION OF THE PREFERRED EMBODIMENTS

Embodiments of the present disclosure will be described with reference to the drawings. In the drawings referred to below, the same or corresponding members are denoted by the same reference numerals.

### Embodiment 1

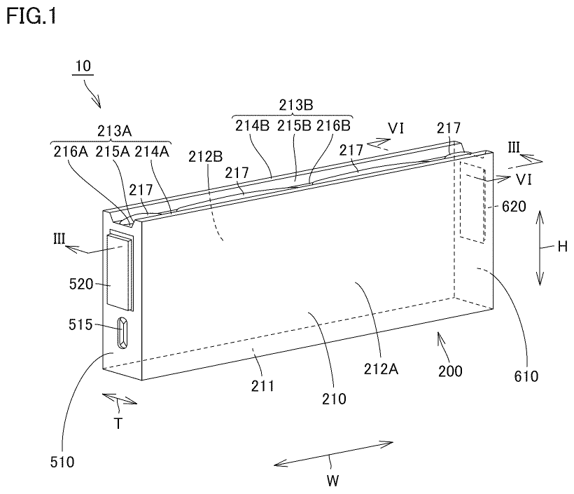

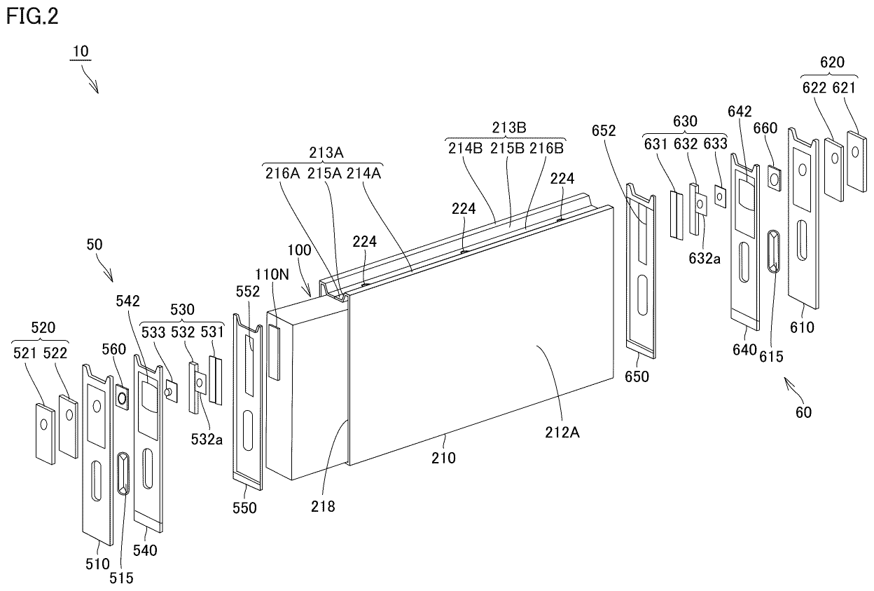

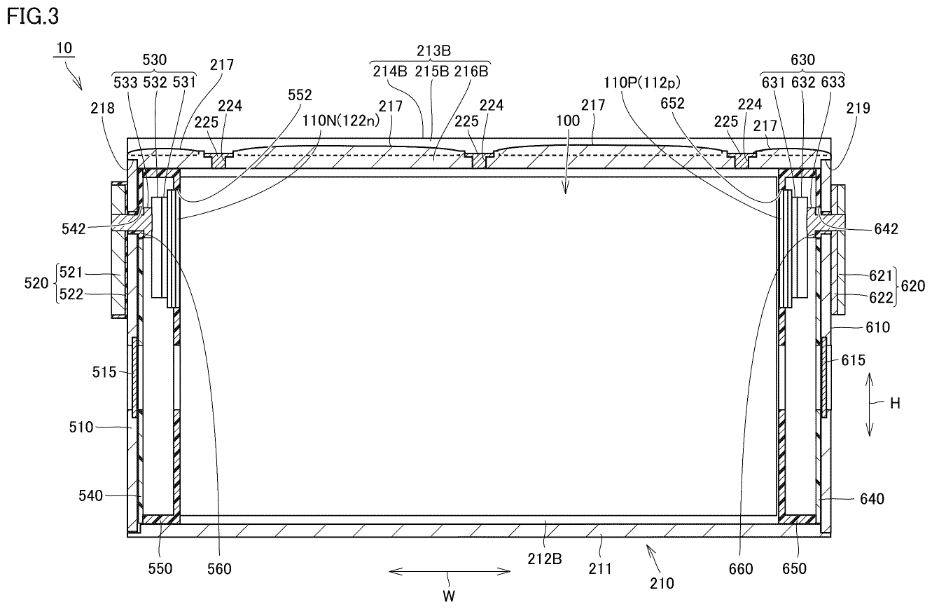

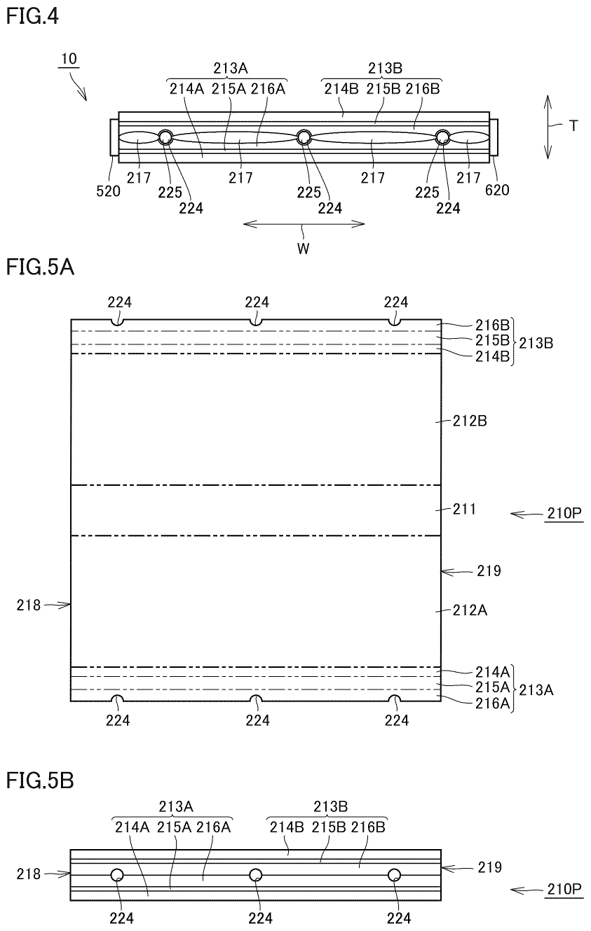

FIG. 1 is a perspective view of a secondary battery according to a first embodiment. FIG. 2 is an exploded perspective view of the secondary battery according to the first embodiment. FIG. 3 is a cross-sectional view taken along the line III-III shown in FIG. 1. FIG. 4 is a plan view of the secondary battery according to the first embodiment.

As shown in FIGS. 1 to 4, the secondary battery 10 according to the first embodiment includes an electrode assembly 100, a housing 200, a positive electrode member 620 as a positive electrode terminal, and a negative electrode member 520 as a negative electrode terminal.

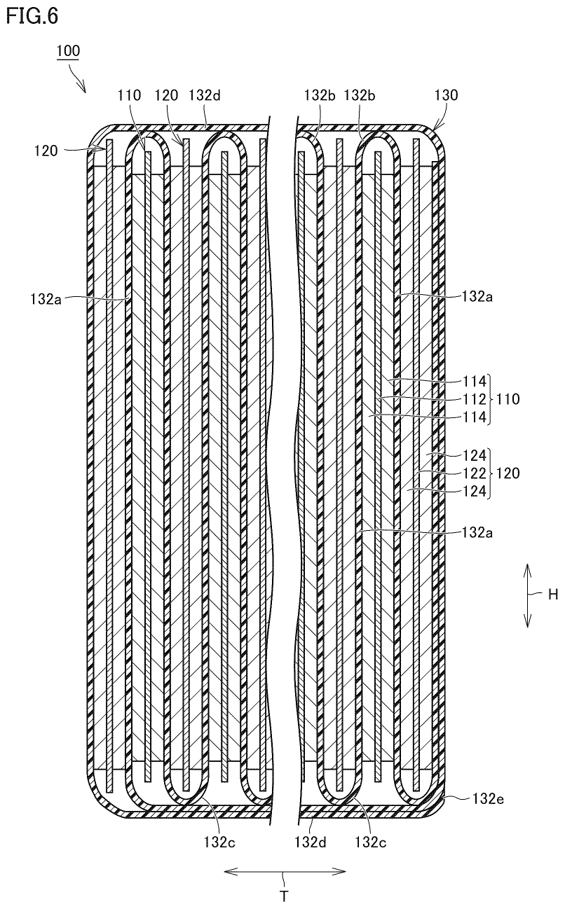

The housing 200 has a substantially rectangular parallelepiped shape. The housing 200 is configured such that the dimension in the width direction W is longer than the dimension in the height direction H and the dimension in the thickness direction T. The thickness direction T is a direction orthogonal to the height direction H. Further, the housing 200 is configured such that the dimension in the height direction H is longer than the dimension in the thickness direction T. The thickness direction T is a direction parallel to a direction in which the positive electrode 110 and the negative electrode 120 (see FIG. 6) described later are arranged side by side. The width direction W is a direction orthogonal to both the height direction H and the thickness direction T.

The housing 200 houses the electrode assembly 100 and an electrolyte solution (not shown) therein. The housing 200 includes a main body 210, a first sealing body 510, and a second sealing body 610.

The main body 210 has a tubular shape in which a first opening 218 and a second opening 219 are respectively provided on both sides in the width direction W. The first opening 218 is provided on one side in the width direction W, and the second opening 219 is provided on the other side in the width direction W. The main body 210 is made of metal such as aluminum.

The main body 210 includes a bottom surface portion 211, a first side surface portion 212A, a second side surface portion 212B, a first top surface portion 213A, a second top surface portion 213B, and a weld 217.

The bottom surface portion 211 is positioned on one side in the height direction H. The bottom surface portion 211 has a rectangular outer shape when viewed from the height direction H.

The first side surface portion 212A extends upright from one end of the bottom surface portion 211 in the thickness direction T along the height direction H. The second side surface portion 212B extends upright from the other end of the bottom surface portion 211 in the thickness direction T along the height direction H. The first side surface portion 212A and the second side surface portion 212B have a rectangular outer shape when viewed from the thickness direction T. The first side surface portion 212A and the second side surface portion 212B may be inclined with respect to the height direction H. The first side surface portion 212A and the second side surface portion 212B may extend closer to each other away from the bottom surface portion 211.

The first top surface portion 213A extends from an end portion opposite to the bottom surface portion 211 side of the first side surface portion 212A toward the second side surface portion 212B.

The first top surface portion 213A includes a first base portion 214A, a first inner surface portion 215A, and a first leading end portion 216A. The first base portion 214A is contiguous from the first side surface portion 212A and extends along the thickness direction T. The first inner surface portion 215A extends from the first base portion 214A toward the bottom surface portion 211. The first inner surface portion 215A is inclined obliquely with respect to the height direction H. The first leading end portion 216A extends from the first inner surface portion 215A along the thickness direction T, and has a leading end of the first top surface portion 213A.

The second top surface portion 213B extends from an end portion opposite to the bottom surface portion 211 side of the second side surface portion 212B toward the first side surface portion 212A.

The second top surface portion 213B includes a second base portion 214B, a second inner surface portion 215B, and a second leading end portion 216B. The second base portion 214B is contiguous from the second side surface portion 212B and extends along the thickness direction T. The second inner surface portion 215B extends from the second base portion 214B toward the bottom surface portion 211 side. The second inner surface portion 215B is inclined obliquely with respect to the height direction H. The second leading end portion 216B extends from the second inner surface portion 215B along the thickness direction T, and has a leading end of the second top surface portion 213B.

The weld 217 connects the leading end of the first top surface portion 213A and the leading end of the second top surface portion 213B to each other. That is, the weld 217 is formed by connecting the leading end of the first top surface portion 213A and the leading end of the second top surface portion 213B by welding. The welding method is not particularly limited, but may be, for example, laser welding. The weld 217 includes a weld bead formed by the welding. The weld bead protrudes from the first top surface portion 213A and the second top surface portion 213B to the side opposite to the bottom surface portion 211 side.

The weld 217 extends only in one direction along the width direction W. The weld 217 is located on the first leading end portion 216A and the second leading end portion 216B, and is located closer to the bottom surface portion 211 in the height direction H than the first base portion 214A and the second base portion 214B.

In the present embodiment, the main body 210 includes a plurality of welds 217 as the welds 217. The plurality of welds 217 are spaced apart from each other. The plurality of welds 217 are arranged in the width direction W.

The main body 210 further includes a liquid injection port 224 and a sealing member 225. The sealing member 225 seals the liquid injection port 224. The liquid injection port 224 is a through hole for injecting an electrolyte solution into the housing 200 during the manufacturing process of the secondary battery 10. The liquid injection port 224 is sealed by a sealing member 225. The sealing member 225 seals the liquid injection port 224 after the electrolyte solution is injected into the housing 200.

In this embodiment, the liquid injection port 224 is provided between the first leading end portion 216A and the second leading end portion 216B. The sealing member 225 is positioned closer to the bottom surface portion 211 in the height direction H than the first base portion 214A and the second base portion 214B. The shape of the hole of the liquid injection port 224 is not particularly limited, but is, for example, a circular shape.

In the present embodiment, the main body 210 has a plurality of liquid injection ports 224 as the liquid injection ports 224 described above. Thus, by injecting the electrolyte solution from each of the plurality of liquid injection ports 224, the electrolyte solution can efficiently penetrate the entire separator 130 (see FIG. 6) described later. From the viewpoint of improving penetration of the electrolyte solution, it is preferable that at least one liquid injection port 224 is disposed such that a distance from the negative electrode member 520 and a distance from the positive electrode member 620 are substantially equal to each other. It is also preferred that at least one liquid injection port 224 is further disposed closer to the negative electrode member 520 than the positive electrode member 620. It is also preferred that at least one liquid injection port 224 is further disposed closer to the positive electrode member 620 than the negative electrode member 520. The main body 210 preferably has three or more liquid injection ports 224. From the viewpoint of reducing the cost for forming the liquid injection ports 224 and preparing the sealing member 225, the number of the liquid injection ports 224 is preferably smaller.

Here, a method of molding the main body 210 will be described. FIG. 5A is a plan view showing a plate-like member prepared for molding the main body portion in the first embodiment. FIG. 5B is a plan view showing a state immediately after bending the plate-like member in the first embodiment. In the plate-like member 210P shown in FIGS. 5A and 5B, portions corresponding to the respective components of the main body 210 are denoted by the same reference numerals as the reference numerals indicating the respective components of the main body 210.

As shown in FIG. 5A, the plate-like member 210P has a plate-like outer shape. Specifically, the plate-like member 210P is prepared by punching a thin plate made of aluminum. At this time, a plurality of notches corresponding to the liquid injection port 224 are formed in the plate-like member 210P.

Then, as shown in FIGS. 5A and 5B, by bending the plate-like member 210P at a plurality of locations, the bottom surface portion 211, the first side surface portion 212A, the second side surface portion 212B, the first top surface portion 213A, and the second top surface portion 213B are molded. Therefore, the main body 210 can be easily molded into various sizes. Each of the above-described surface portions may be molded by roll forming the plate-like member 210P.

Then, by welding the leading ends of the plate-like members 210P molded in this manner so as to avoid a notch corresponding to the liquid injection port 224, the weld 217 is formed (see FIG. 4), and the main body 210 is molded.

As shown in FIGS. 1 to 3, the first sealing body 510 closes the first opening 218. The first sealing body 510 has a flat plate shape. The first sealing body 510 is made of metal such as aluminum. The first sealing body 510 is provided with a negative electrode member 520. The first sealing body 510 is fixed to the first opening 218 by, for example, laser welding. The first sealing body 510 is provided with a pressure release valve 515. The pressure release valve 515 is provided so as to break when the internal pressure of the housing 200 becomes equal to or higher than a predetermined pressure. When the pressure release valve 515 is broken, the gas in the housing 200 is discharged to the outside of the housing 200, so that the internal pressure in the housing 200 decreases. The first sealing body 510 is provided with a negative electrode member 520.

The negative electrode member 520 is provided on the outer surface of the first sealing body 510. The negative electrode member 520 functions as a negative electrode terminal. The negative electrode member 520 includes a negative electrode terminal plate 521 and an insulating plate 522.

The negative electrode terminal plate 521 is formed in a substantially rectangular parallelepiped shape. The negative electrode terminal plate 521 is held by an insulating plate 522. The insulating plate 522 is fixed to the outer surface of the first sealing body 510. The insulating plate 522 insulates the first sealing body 510 from the negative electrode terminal plate 521. Each of the negative electrode terminal plate 521 and the insulating plate 522 is provided with a through hole through which a negative electrode connecting pin 533 described later is inserted.

The second sealing body 610 closes the second opening 219. The second sealing body 610 has a flat plate shape. The second sealing body 610 is made of metal such as aluminum. The second sealing body 610 is provided with a positive electrode member 620. The second sealing body 610 is fixed to the second opening 219 by, for example, laser welding. The second sealing body 610 is provided with a pressure release valve 615. The pressure release valve 615 is provided so as to break when the internal pressure of the housing 200 becomes equal to or higher than a predetermined pressure. When the pressure release valve 615 is broken, the gas in the housing 200 is discharged to the outside of the housing 200, so that the internal pressure in the housing 200 decreases. The second sealing body 610 is provided with a positive electrode member 620.

The positive electrode member 620 is provided on the outer surface of the second sealing body 610. The positive electrode member 620 functions as a positive electrode terminal. The positive electrode member 620 includes a positive electrode terminal plate 621 and a terminal block 622.

The positive electrode terminal plate 621 is formed in a rectangular parallelepiped shape. The positive electrode terminal plate 621 is made of a metal such as aluminum.

The terminal block 622 is formed in a rectangular parallelepiped shape. The terminal block 622 is made of a metal (e.g., iron) different from the metal constituting the positive electrode terminal plate 621. The terminal block 622 is fixed to the outer surface of the second sealing body 610 by welding or the like. The positive electrode terminal plate 621 is fixed to the terminal block 622 by welding or the like. The main body 210 and the second sealing body 610 are electrically connected to the positive electrode terminal plate 621 via the terminal block 622, and are charged to the same polarity as the positive electrode terminal plate 621. Each of the positive electrode terminal plate 621 and the terminal block 622 is formed with a through hole through which a positive electrode connecting pin 633 described later is inserted.

An insulating plate may be disposed between the positive electrode member 620 and the second sealing body 610 to electrically insulate the positive electrode member 620 from the second sealing body 610. In this case, an insulating plate may be disposed instead of the terminal block 622, or an insulating plate may be disposed between the terminal block 622 and the second sealing body 610.

The secondary battery 10 further includes a negative electrode connecting member 530, a negative-electrode-side first insulating member 540, a negative-electrode-side second insulating member 550, and an insulator 560 on the negative electrode member 520 side.

The negative electrode connecting member 530 connects the negative electrode current collecting portion 110N and the negative electrode terminal plate 521. The negative electrode current collecting portion 110N is formed by bundling a plurality of negative electrode tabs 122n to be described later in the electrode assembly 100. The negative electrode connecting member 530 includes a negative-electrode-side first current collector 531, a negative-electrode-side second current collector 532, and a negative electrode connecting pin 533.

The negative-electrode-side first current collector 531 is formed of a thin plate-like conductive member. The negative-electrode-side first current collector 531 is connected to the negative electrode current collecting portion 110N by laser welding, ultrasonic welding, or the like.

The negative-electrode-side second current collector 532 is formed of a thin plate-like conductive member. The negative-electrode-side second current collector 532 is connected to the negative-electrode-side first current collector 531 by laser welding, ultrasonic welding, or the like. The negative-electrode-side second current collector 532 has a holding portion 532a for holding the negative electrode connecting pin 533. The holding portion 532a has a flat plate shape. The holding portion 532a is provided with a through hole into which the proximal end of the negative electrode connecting pin 533 is inserted.

The negative electrode connecting pin 533 connects the negative-electrode-side second current collector 532 and the negative electrode terminal plate 521. The negative electrode connecting pin 533 includes a cylindrical portion. The leading end side of the cylindrical portion penetrates the first sealing body 510, the insulating plate 522, and the negative electrode terminal plate 521, and is caulked to the negative electrode terminal plate 521.

The negative-electrode-side first insulating member 540 has a substantially plate shape. The negative-electrode-side first insulating member 540 is disposed so as to contact the inner surface of the first sealing body 510. A through hole 542 through which the negative electrode connecting pin 533 is inserted is formed in the negative-electrode-side first insulating member 540.

The negative-electrode-side second insulating member 550 is disposed between the negative-electrode-side first insulating member 540 and the electrode assembly 100. The negative-electrode-side second insulating member 550 is provided with a slit 552 through which the negative electrode current collecting portion 110N is inserted.

The negative-electrode-side first insulating member 540 and the negative-electrode-side second insulating member 550 are assembled such that a storage space is formed therebetween. A negative electrode current collecting portion 110N, a negative-electrode-side first current collector 531, and a negative-electrode-side second current collector 532 inserted through the slit 552 are disposed in the housing space.

The insulator 560 has a shape that covers the cylindrical portion of the negative electrode connecting pin 533. The insulator 560 insulates the negative electrode connecting pin 533 from the housing 200 (more specifically, the first sealing body 510).

The negative electrode member 520, the first sealing body 510, the negative electrode connecting member 530, the negative-electrode-side first insulating member 540, the negative-electrode-side second insulating member 550, and the insulator 560 are assembled to form the first lid assembly 50.

The first lid assembly 50 is fixed to the main body 210 by attaching the first sealing body 510 to the first opening 218 in a state where the negative electrode current collecting portion 110N and the negative electrode connecting member 530 are fixed by welding or the like.

The secondary battery 10 further includes, on the positive electrode member 620 side, a positive electrode connecting member 630, a positive-electrode-side first insulating member 640, a positive-electrode-side second insulating member 650, and an insulator 660.

The positive electrode connecting member 630 connects the positive electrode current collecting portion 110P and the positive electrode terminal plate 621. The positive electrode current collecting portion 110P is formed by bundling a plurality of positive electrode tabs 112p to be described later in the electrode assembly 100. The positive electrode connecting member 630 includes a positive-electrode-side first current collector 631, a positive-electrode-side second current collector 632, and a positive electrode connecting pin 633.

The positive-electrode-side first current collector 631 is formed of a thin plate-like conductive member. The positive-electrode-side first current collector 631 is connected to the positive electrode current collecting portion 110P by laser welding, ultrasonic welding, or the like.

The positive-electrode-side second current collector 632 is formed of a thin plate-like conductive member. The positive-electrode-side second current collector 632 is connected to the positive-electrode-side first current collector 631 by laser welding, ultrasonic welding, or the like. The positive-electrode-side second current collector 632 has a holding portion 632a for holding the positive electrode connecting pin 633. The holding portion 632a has a flat plate shape. The holding portion 632a is provided with a through hole into which the base end of the positive electrode connecting pin 633 is inserted.

The positive electrode connecting pin 633 connects the positive-electrode-side second current collector 632 and the positive electrode terminal plate 621. The positive electrode connecting pin 633 includes a cylindrical portion. The leading end side of the cylindrical portion passes through the second sealing body 610, the terminal block 622, and the positive electrode terminal plate 621, and is caulked to the positive electrode terminal plate 621.

The positive-electrode-side first insulating member 640 has a substantially plate shape. The positive-electrode-side first insulating member 640 is disposed in contact with the inner surface of the second sealing body 610. The positive-electrode-side first insulating member 640 is provided with a through hole 642 through which the positive electrode connecting pin 633 is inserted.

The positive-electrode-side second insulating member 650 is disposed between the positive-electrode-side first insulating member 640 and the electrode assembly 100. The positive-electrode-side second insulating member 650 is provided with a slit 652 through which the positive electrode current collecting portion 110P is inserted.

The positive-electrode-side first insulating member 540 and the positive-electrode-side second insulating member 550 are assembled such that a storage space is formed therebetween. A positive electrode current collecting portion 110P, a positive-electrode-side first current collector 631, and a positive-electrode-side second current collector 632 inserted through the slit 552 are disposed in the housing space.

The insulator 660 has a shape that covers the cylindrical portion of the positive electrode connecting pin 633. The insulator 660 insulates the positive electrode connecting pin 633 from the housing 200 (more specifically, the second sealing body 610).

The positive electrode member 620, the second sealing body 610, the positive electrode connecting member 630, the positive-electrode-side first insulating member 640, the positive-electrode-side second insulating member 650, and the insulator 660 are incorporated to form the second lid assembly 60.

The second lid assembly 60 is fixed to the main body 210 by attaching the second sealing body 610 to the second opening 219 in a state where the positive electrode current collecting portion 110P and the positive electrode connecting member 630 are fixed by welding or the like.

FIG. 6 is a cross-sectional view taken along the line VI-VI shown in FIG. 1. In FIG. 6, for the sake of convenience, the housing 200 of the secondary battery 10 is omitted, and only the electrode assembly 100 is shown. The details of the electrode assembly 100 will be described with reference to FIG. 6.

As shown in FIG. 6, the electrode assembly 100 includes a plurality of positive electrodes 110, a plurality of negative electrodes 120, and a separator 130. The plurality of positive electrodes 110 and the plurality of negative electrodes 120 are arranged alternately in the thickness direction T while being insulated by the separator 130.

Each of the negative electrodes 120 is formed in a rectangular shape in which the width direction W is the long side and the height direction H is the short side. Each negative electrode 120 includes a negative electrode current collector foil 122 and a negative electrode active material layer 124 provided on both surfaces of the negative electrode current collector foil 122. The negative electrode current collector foil 122 has a negative electrode tab 122n (see FIG. 3) in which the negative electrode active material layer 124 is not provided. The negative electrode tab 122n protrudes toward one side in the width direction W.

Each positive electrode 110 is formed in a rectangular shape in which the width direction W is the long side and the height direction H is the short side. Each positive electrode 110 includes a positive electrode current collector foil 112, and positive electrode active material layers 114 provided on both surfaces of the positive electrode current collector foil 112 in the thickness direction T. The positive electrode current collector foil 112 has a positive electrode tab 112p (see FIG. 3) in which the positive electrode active material layer 114 is not provided. The positive electrode tab 112p protrudes toward the other side in the width direction W.

The separator 130 insulates the positive electrode 110 from the negative electrode 120. The separator 130 is made of an insulating material, and has minute voids that allow penetration of ions. The separator 130 is folded.

The separator 130 has a rectangular shape before being folded. The separator 130 is disposed between the positive electrode 110 and the negative electrode 120 in a folded state. The separator 130 includes a plurality of intervening portions 132a, a plurality of first folded portions 132b, a plurality of second folded portions 132c, and an outermost covering portion 132d.

The intervening portions 132a are interposed between the positive electrode 110 and the negative electrode 120 adjacent to each other in the thickness direction T. That is, each intervening portion 132a has a function of insulating the positive electrode 110 and the negative electrode 120. Each intervening portion 132a is configured by a rectangular region.

The first folded portions 132b connect one end of the intervening portions 132a in the height direction H adjacent to each other in the thickness direction T so that the positive electrodes 110 are positioned therebetween. The first folded portion 132b is disposed on one side (upper side) in the height direction H of the positive electrode 110.

The second folded portions 132c connect the other end portions of the intervening portions 132a adjacent to each other in the thickness direction T in the height direction H so that the negative electrodes 120 are positioned therebetween. The second folded portion 132c is disposed on the other side (lower side) of the negative electrode 120 in the height direction H.

The outermost covering portions 132d collectively cover the first folded portions 132b and the second folded portions 132c. More specifically, the outermost covering portion 132d covers all of the positive electrodes 110, all of the negative electrodes 120, all of the intervening portions 132a, all of the first folded portions 132b, and all of the second folded portions 132c while winding around the central axis parallel to the width direction W. The terminal end 132e of the outermost covering portion 132d is set in a range not overlapping the positive electrode active material layer 114 and the negative electrode active material layer 124 in the thickness direction T. In the present embodiment, the terminal end 132e of the outermost covering portion 132d is provided below each positive electrode 110 and each negative electrode 120. The peripheral surfaces and bottom surfaces of the plurality of positive electrodes 110, the plurality of negative electrodes 120, and the separator 130 may be covered with an insulating film (not shown).

As described above, in the secondary battery 10 according to the first embodiment of the present disclosure, the main body 210 has a tubular shape. The main body 210 includes a bottom surface portion 211, a first side surface portion 212A, a second side surface portion 212B, a first top surface portion 213A, a second top surface portion 213B, and a weld 217. The bottom surface portion 211 is positioned on one side in the height direction H. The first side surface portion 212A extends upright from one end of the bottom surface portion 211 in the thickness direction T along the height direction H. The second side surface portion 212B extends upright from the other end of the bottom surface portion 211 in the thickness direction T along the height direction H. The first top surface portion 213A extends from an end portion opposite to the bottom surface portion 211 side of the first side surface portion 212A toward the second side surface portion 212B. The second top surface portion 213B extends from an end portion opposite to the bottom surface portion 211 side of the second side surface portion 212B toward the first side surface portion 212A. The weld 217 connects the leading end of the first top surface portion 213A and the leading end of the second top surface portion 213B to each other.

According to the above configuration, the welding length on the side opposite to the bottom surface portion 211 can be shortened as compared with the case where the housing 200 has the opening on the side opposite to the bottom surface portion 211. Consequently, welding strain of the housing 200 can be suppressed. In particular, when the housing 200 has a long dimension in the width direction W, the welding length can be reduced more effectively.

In this embodiment, the weld 217 extends only in one direction along the width direction W. According to this configuration, the welding length can be further shortened, and the welding strain of the housing 200 can be further suppressed.

In this embodiment, the first top surface portion 213A includes a first base portion 214A, a first inner surface portion 215A, and a first leading end portion 216A. The first base portion 214A is contiguous from the first side surface portion 212A and extends along the thickness direction T. The first inner surface portion 215A extends from the first base portion 214A toward the bottom surface portion 211. The first leading end portion 216A extends from the first inner surface portion 215A along the thickness direction T, and has a leading end of the first top surface portion 213A. The second top surface portion 213B includes a second base portion 214B, a second inner surface portion 215B, and a second leading end portion 216B. The second base portion 214B is contiguous from the second side surface portion 212B and extends along the thickness direction T. The second inner surface portion 215B extends from the second base portion 214B toward the bottom surface portion 211 side. The second leading end portion 216B extends from the second inner surface portion 215B along the thickness direction T, and has a leading end of the second top surface portion 213B. The weld 217 is located on the first leading end portion 216A and the second leading end portion 216B, and is located closer to the bottom surface portion 211 in the height direction H than the first base portion 214A and the second base portion 214B.

According to the above configuration, contact of the weld 217 with other articles outside the secondary battery 10 can be suppressed. Therefore, handling of the secondary battery 10 becomes easier.

In this embodiment, the main body 210 further includes a liquid injection port 224 and a sealing member 225. The liquid injection port 224 is provided between the first leading end portion 216A and the second leading end portion 216B. The sealing member 225 seals the liquid injection port 224. The sealing member 225 is positioned closer to the bottom surface portion 211 in the height direction H than the first base portion 214A and the second base portion 214B.

According to the above configuration, the liquid injection port 224 can be easily provided without punching out the plate-like member constituting the main body 210. In addition, contact of the sealing member 225 with other articles outside the secondary battery 10 can be suppressed. Therefore, handling of the secondary battery 10 becomes easier.

### Embodiment 2

Next, a secondary battery according to a second embodiment of the present disclosure will be described. The secondary battery according to the second embodiment of the present disclosure is different from the secondary battery 10 according to the first embodiment of the present disclosure in the configuration of a liquid injection port, a weld, and the like. Therefore, the description of the same configuration as the secondary battery 10 according to the first embodiment of the present disclosure will not be repeated.

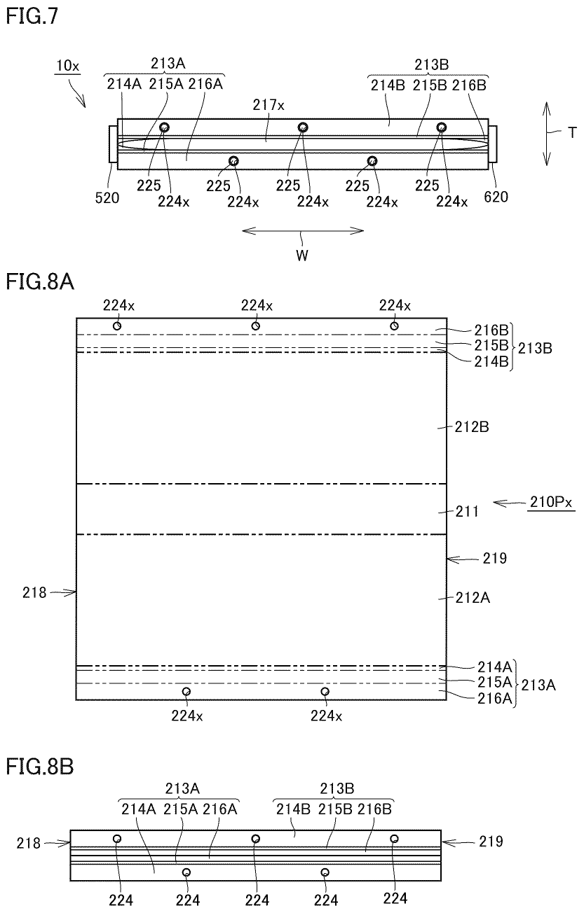

FIG. 7 is a plan view of a secondary battery according to a second embodiment. As shown in FIG. 7, in the secondary battery 10x according to the second embodiment of the present disclosure, the liquid injection port 224x is provided in at least one of the first base portion 214A and the second base portion 214B. As a result, since the liquid injection port 224x is more reliably positioned away from the weld 217x, the sealing member 225 can be easily attached to the liquid injection port 224x without being brought into contact with the weld 217x, as compared with the first embodiment. In the present embodiment, a plurality of liquid injection ports 224x are provided in each of the first base portion 214A and the second base portion 214B.

FIG. 8A is a plan view showing a plate-like member prepared for molding the main body portion in the second embodiment. FIG. 8B is a plan view showing a state immediately after bending the plate-like member in the second embodiment. In the plate-like member 210Px shown in FIGS. 8A and 8B, portions corresponding to the respective configurations of the main body 210 in the second embodiment are denoted by the same reference numerals as the reference numerals indicating the respective configurations of the main body 210.

As shown in FIGS. 8A and 8B, in the second embodiment of the present disclosure, a plurality of liquid injection ports 224x are formed in advance by punching out the plate-like member 210Px.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A secondary battery comprising:
an electrode assembly; and
a housing containing the electrode assembly, wherein
the housing has a dimension in a height direction, a dimension in a thickness direction orthogonal to the height direction, and a dimension in a width direction orthogonal to both the height direction and the thickness direction, and the dimension in the width direction is longer than the dimension in the height direction and the dimension in the thickness direction,
the housing includes: a main body having a tubular shape and provided with a first opening and a second opening that are located on opposite ends in the width direction, respectively; and a first sealing body closing the first opening and a second sealing body closing the second opening,
the main body includes:
a bottom surface portion located on one side in the height direction;
a first side surface portion extending upright along the height direction, from one end of the bottom surface portion in the thickness direction;
a second side surface portion extending upright along the height direction, from the other end of the bottom surface portion in the thickness direction;
a first top surface portion extending toward the second side surface portion, from an end of the first side surface portion, the end being located opposite to the bottom surface portion;
a second top surface portion extending toward the first side surface portion, from an end of the second side surface portion, the end being located opposite to the bottom surface portion; and
a weld connecting a leading end of the first top surface portion and a leading end of the second top surface portion to each other.

2. The secondary battery according to claim 1, wherein the weld extends only in one direction along the width direction.

3. The secondary battery according to claim 1, wherein
the first top surface portion includes: a first base portion contiguous from the first side surface portion and extending along the thickness direction; a first inner surface portion extending from the first base portion toward the bottom surface portion;
and a first leading end portion extending from the first inner surface portion along the thickness direction and including a leading end of the first top surface portion, the second top surface portion includes: a second base portion contiguous from the second side surface portion and extending along the thickness direction; a second inner surface portion extending from the second base portion toward the bottom surface portion; and a second leading end portion extending from the second inner surface portion along the thickness direction and including a leading end of the second top surface portion, and
the weld is located on the first leading end portion and the second leading end portion, and located closer to the bottom surface portion in the height direction, than the first base portion and the second base portion.

4. The secondary battery according to claim 3, wherein
the main body further includes: a liquid injection port provided between the first leading end portion and the second leading end portion; and a sealing member sealing the liquid injection port, and
the sealing member is located closer to the bottom surface portion in the height direction, than the first base portion and the second base portion.

5. The secondary battery according to claim 3, wherein the main body further includes: a liquid injection port provided in at least one of the first base portion and the second base portion; and a sealing member sealing the liquid injection port.

6. The secondary battery according to claim 4, wherein the weld extends only in one direction along the width direction.

7. The secondary battery according to claim 5, wherein the weld extends only in one direction along the width direction.
